(19) United States
(12) Patent Application Publication
(10) Pub. No.: US 2004/0224107 A1
(43) Pub. Date: Nov. 11, 2004

(54) Fiber-optic mouse pad

(76) Inventor: Edward D. Lewis, Brownsburg, IN (US)

Correspondence Address: BAHRET & ASSOCIATES, 320 NORTH MERIDIAN STREET, SUITE 512, INDIANAPOLIS, IN, 46204, US

(21) Appl. No.: 10/772,144

(22) Filed: Feb. 4, 2004

Related U.S. Application Data
(60) Provisional application No. 60/445,126, filed on Feb. 5, 2003.

(51) Int. Cl. F16L 1/00

(52) U.S. Cl. 428/34.1

(57) ABSTRACT

A fiber-optic mouse pad for use with an optical mouse. The mouse pad has a substantially opaque top surface and a plurality of optical fibers extending a distance laterally under the top surface, the optical fibers being bundled together on a first end to define a common light inlet exposed to light emitted from the optical mouse during normal use thereof, the optical fibers having second ends extending through the top surface at remote points defining a desired illumination pattern. The construction of the fiber-optic mouse pad enables the desired illumination pattern to be illuminated remotely by moving the optical mouse over the light inlet.

### CROSS-REFERENCE TO RELATED APPLICATION

This application claims the benefit of U.S. Provisional Patent Application Ser. No. 60/445,126, filed Feb. 5, 2003, which application is hereby incorporated by reference.

### BACKGROUND OF THE INVENTION

The present invention relates to mouse pads and, more particularly, to mouse pads having a name, slogan, logo or other pattern displayed on a surface thereof.

The computer mouse is a ubiquitous input device for personal computers, and is available in numerous forms and styles in two main categories, i.e., electromechanical and optical mice. The associated mouse pad is also ubiquitous and has been produced in various forms and styles with countless different designs and images on its working surface. The demand for mouse pads with distinctive visual appearances—artistic, personalized or promotional—knows no bounds.

One known mouse pad has surface disruptions which are designed to provide superior optical tracking with an optical mouse, and which reportedly also produce a glow around an optical mouse while the mouse is in contact with the surface. While such a mouse pad may produce an interesting effect immediately adjacent to the moving mouse, a need remains for mouse pads capable of producing distinctive visual effects, particularly effects that appear not to emanate from the mouse itself.

### SUMMARY OF THE INVENTION

The present invention provides a fiber-optic mouse pad for use with an optical mouse. The mouse pad has a top surface for receiving an optical mouse, and a plurality of optical fibers extending a distance laterally under the top surface, the optical fibers being bundled together on a first end to define a common light inlet exposed to light emitted from the optical mouse during normal use thereof, the optical fibers having second ends extending through the top surface at different points defining a desired illumination pattern. The construction of the fiber-optic mouse pad enables the desired illumination pattern to be illuminated remotely by moving the optical mouse over the light inlet.

The objects and advantages of the present invention will be more apparent upon reading the following detailed description in conjunction with the accompanying drawings.

### BRIEF DESCRIPTION OF THE DRAWINGS

FIG. 1 is a top view of one embodiment of a fiber-optic mouse pad according to the present invention.

FIG. 2 is a front view of the mouse pad of FIG. 1.

FIG. 3 is an enlarged fragmentary cross-section of the mouse pad taken along line 3-3 of FIG. 1.

FIG. 4 is a top view of another embodiment of a fiber-optic mouse pad according to the present invention.

FIG. 5 is a perspective view of a light collector in the mouse pad of FIG. 4.

### DESCRIPTION OF PREFERRED EMBODIMENTS

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

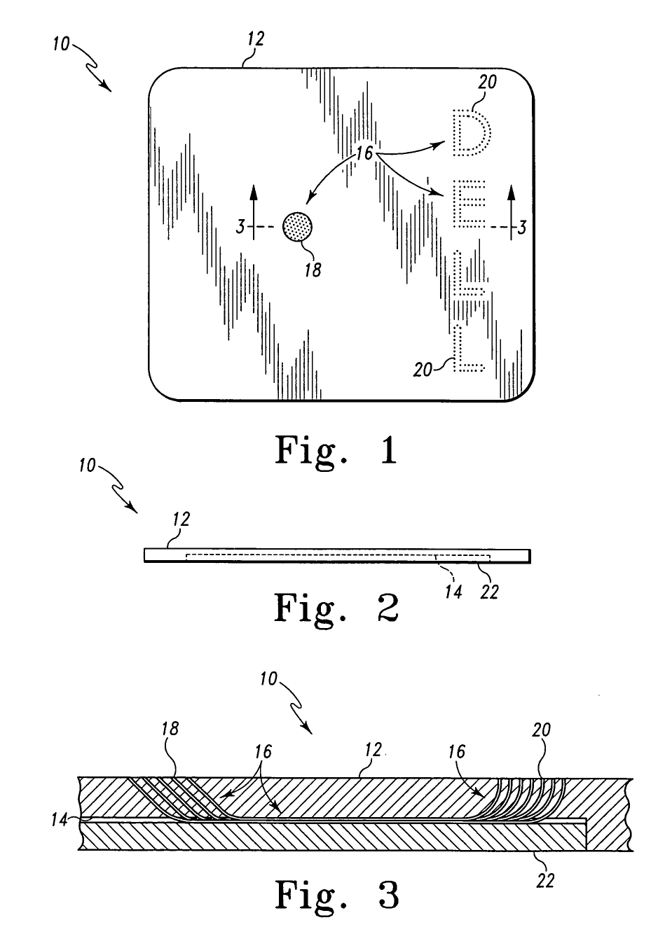

As shown in FIGS. 1-3, one embodiment of a mouse pad 10 according to the present invention comprises a sheet 12 of rubber or other suitable material for a conventional mouse pad, with a bottom side recess 14 and with a plurality of optical fibers 16 terminated on both ends at the top surface of the mouse pad. Sheet 12 may be made of open-cell sponge rubber or foam, for example, or polyester fabric on non-skid rubber. The fibers are bundled together on one end 18 and are separated on the other end 20 to form a desired pattern or patterns on the surface of sheet 12. For example, the fibers may be arranged to form the word “DELL” as illustrated in FIG. 1. The middle portion of each fiber runs laterally through the recess, as shown in FIG. 3, and is covered by a bottom insert 22 which may have essentially the same length, width and depth as the recess and may be secured therein adhesively or thermally, for example. The fibers may thus be pressed between the bottom surface of recess 14 and the top surface of bottom insert 22, leaving essentially no gap, although a gap is shown in FIG. 3 for illustration purposes.

In one embodiment, the pad is substantially rectangular, approximately 7″ by 8″, with a thickness of approximately 0.17″, and the fibers are inserted through sheet 12 at an oblique angle, e.g., 50-55°, at least at the bundled end 18. The thickness of each optical fiber is preferably in the range of 0.015-0.020″. In other embodiments, the pad is thicker and/or thinner fibers are used. The ends of the fibers may be inserted through the sheet from the bottom side thereof and shaved off flush with the top surface of the sheet. Heat is applied to melt the exposed fiber tips sufficiently to cause slight mushrooming thereof at the top surface of the pad.

The fibers are bundled on one end 18 in the central part of the mouse pad in order to receive light from an optical mouse as it is moved across the mouse pad during normal use. Light entering the fibers at end 18 is emitted at the other end as points of light forming the desired name, slogan, logo or other light pattern. Fiber insertion at an angle facilitates the construction of a thinner mouse pad, and can also increase the transmission of light from an optical mouse. Most optical mice have an LED mounted so as to emit light at a downward angle. The mouse pad preferably has the optical fibers on the bundled end 18 set at an angle substantially the same as that of the LED in a typical optical mouse such that the angled fibers and LED are substantially aligned when the mouse in positioned over the bundled end in its normal orientation on the mouse pad.

In an alternative embodiment, the mouse pad is made of injection molded parts, including a cradle or base, a top plate, and a light-conducting structure or structures performing the function of the optical fibers described above. For example, a spider-like network of light pipes or conductors may be injection molded with a common circular inlet, corresponding to bundled end 18 of the fibers, and multiple light conductors or legs extending from the common inlet to individual outlets as at the end 20 of the fibers. Alternatively, a given light conductor may have its outlet end formed in the shape of a solid letter or a segment thereof rather than as a single dot in the outline of a letter. Such an injection-molded or otherwise preformed light-conducting network may be positioned in a preformed base and then covered with a top plate which is preformed with holes to receive the inlet and outlet ends of the light conductors, with clearance provided if necessary, on the order of a few thousandths of an inch for example, to allow for tolerances and to otherwise facilitate assembly. The top plate and base may also be formed so as to snap together. In addition, the product may have multiple light-conducting networks such as just described, each one having its own associated word, slogan, logo or other pattern which is illuminated when an optical mouse is moved over the associated inlet.

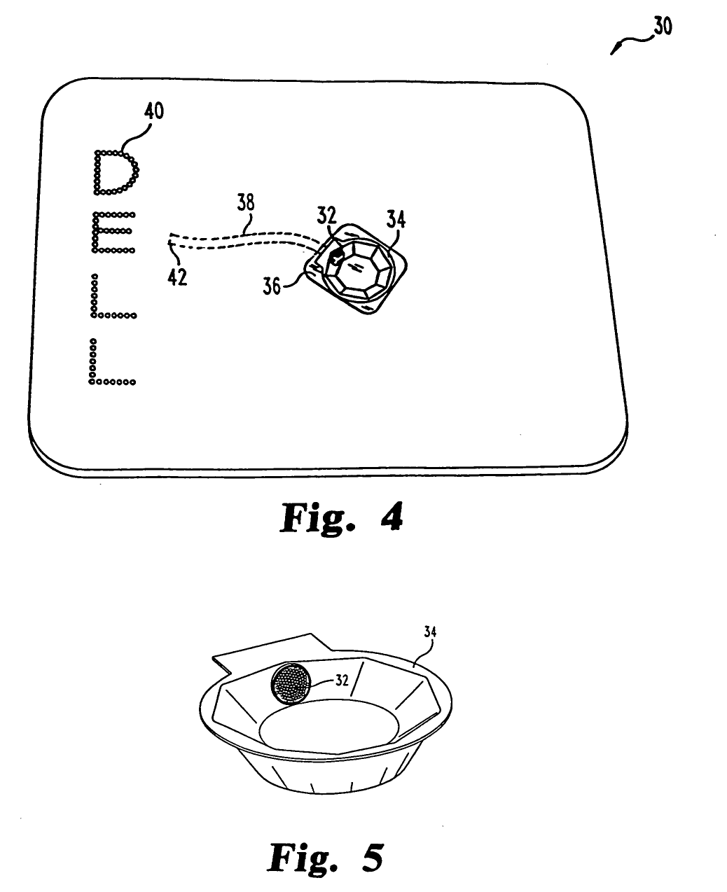

In another embodiment of the present invention, illustrated in FIGS. 4 and 5, a mouse pad 30 has the bundled end 32 of a plurality of optical fibers terminated in a side wall of a reflective cup 34 which is embedded in the mouse pad and covered by a clear piece of acrylic or other suitable material forming a window 36 having a top surface substantially flush with the top surface of the mouse pad. The pad may have multiple layers, including a relatively thin top layer of polyester fabric or other conventional material for the mouse contact surface of the pad, a thicker lower layer of open-cell sponge rubber or foam, e.g., approximately ⅛″ thick, affixed to the bottom surface of the top layer, and a non-skid bottom layer affixed to the bottom surface of the lower layer. The mouse pad preferably includes a sub-surface channel or tunnel 38 extending from the cup toward a desired illumination pattern 40, whereby the optical fibers may run together a distance laterally under the top surface of the pad and thereby transmit light from the common light inlet to the opposite ends of the fibers, which are thus illuminated remotely when an optical mouse is moved over the light inlet.

The fibers may be inserted through the attached top and intermediate layers of the pad with the aid of a needle before the non-skid layer is attached, and may then be run separately along the bottom surface of the intermediate layer to the entry 42 of channel 38, where the fibers are gathered, tied together and inserted into the channel. The channel and the space for cup 34 may be die cut through the entire thickness of the intermediate layer, and the channel may be made wider at the channel entry to facilitate fiber bundling without creating a bulge. The channel entry may also be tapered vertically such that its height, measured from the bottom surface of the intermediate layer, decreases with distance away from the main portion of the channel. Cover 30 and cup 34 may both be injection molded, and the cup may be chrome plated at least on its inner wall to enhance the reflection of light. The reflective cup, which may have an octagonal inner wall comprising multiple reflective surfaces as shown in the drawings, is one form of light collector contemplated for collecting light emitted from an optical mouse and directing that light toward a sub-surface bundle of fibers, a light pipe or other optical transmission means. Other forms of light collectors are contemplated, including lenses and other refractive or reflective devices. This embodiment of the mouse pad may in other respects be the same as the embodiment of FIGS. 1-3.

While various embodiments of the invention have been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

We claim:

1. A fiber-optic mouse pad for use with an optical mouse, comprising:
a pad having a top surface for receiving an optical mouse; and
a plurality of optical fibers extending a distance laterally under said top surface of said pad, said optical fibers each having first and second ends, said first ends bundled together to define a common light inlet exposed to light emitted from the optical mouse during normal use thereof, said second ends extending through said top surface of said pad at different points defining a desired illumination pattern,
whereby the desired illumination pattern may be illuminated remotely by moving the optical mouse over said light inlet.

2. The fiber-optic mouse pad of claim 1, further comprising a light collector disposed below said top surface of said pad and adjacent to said common light inlet defined by said first ends of said fibers.

3. The fiber-optic mouse pad of claim 2, wherein said light collector includes at least one reflector disposed below said top surface of said pad and oriented so as to reflect downwardly directed light from the optical mouse toward said common light inlet.

4. The fiber-optic mouse pad of claim 3, further comprising a cup embedded in said pad, wherein said at least one reflector is formed as a portion of an inner wall of said cup.

5. The fiber-optic mouse pad of claim 4, wherein said inner wall of said cup is octagonal.

6. The fiber-optic mouse pad of claim 5, wherein said first ends of said fibers are terminated in said cup.

7. The fiber-optic mouse pad of claim 6, further comprising a transparent cover over said cup, said cover having a top surface substantially flush with said top surface of said pad.

8. The fiber-optic mouse pad of claim 7, wherein said pad includes a top layer and a lower layer affixed to each other, wherein said lower layer has a channel formed therein between said common light inlet and a point in proximity to said desired illumination pattern, and wherein said optical fibers are at least partially contained within said channel.

9. The fiber-optic mouse pad of claim 8, further comprising a non-skid layer affixed to the bottom of said lower layer of said pad.

10. The fiber-optic mouse pad of claim 9, wherein said top surface of said pad is substantially opaque.

11. The fiber-optic mouse pad of claim 1, wherein said pad includes a top layer and a lower layer affixed to each other, wherein said lower layer has a channel formed therein between said common light inlet and a point in proximity to said desired illumination pattern, and wherein said optical fibers are at least partially contained within said channel.

12. The fiber-optic mouse pad of claim 11, further comprising a non-skid layer affixed to the bottom of said lower layer of said pad.

13. The fiber-optic mouse pad of claim 12, wherein said top surface of said pad is substantially opaque.

14. A fiber-optic mouse pad for use with an optical mouse, comprising:
a pad having a top surface for receiving an optical mouse, said top surface being substantially opaque;
means contained within said pad for collecting light emitted from the optical mouse on said top surface; and
means optically coupled to said light collecting means for transmitting light under said top surface to a plurality of points remote from the optical mouse and for directing light from said remote points through said top surface.

15. The fiber-optic mouse pad of claim 14, wherein said light collecting means includes at least one reflector oriented so as to reflect downwardly directed light from the optical mouse toward said light transmitting means.

16. The fiber-optic mouse pad of claim 15, further comprising a cup embedded in said pad, wherein said at least one reflector is formed as a portion of an inner wall of said cup.

17. The fiber-optic mouse pad of claim 16, wherein said light transmitting means includes a plurality of optical fibers terminated on a first end in said cup and forming on a second end thereof a pattern of points on said top surface defining a desired illuminated pattern.

18. The fiber-optic mouse pad of claim 14, wherein said light collecting means includes a plurality of optical fibers exposed on a first end to said top surface of said pad, said optical fibers forming on a second end thereof a pattern of points on said top surface defining a desired illuminated pattern.

19. A fiber-optic mouse pad for use with an optical mouse, comprising:
a pad having a top layer with a substantially opaque flat top surface for receiving an optical mouse, and a lower layer affixed to said top layer and having a channel formed therein extending laterally under said top surface between a first area of said pad and a second area of said pad remote from said first area;
a reflective cup embedded in said first area of said pad, said reflective cup having an inner wall defining a plurality of plane reflective surfaces below said top surface;
a transparent cover over said cup, said cover having a flat top surface substantially flush with said top surface of said pad;
a plurality of optical fibers each having first and second ends, said first ends bundled together and terminated in said cup in optical alignment with said reflective surfaces thereof, said optical fibers extending from said cup through said channel to said second area of said pad, said second ends extending separately through said top surface of said pad in said second area thereof in a predetermined pattern,
whereby light emitted from the optical mouse is transmitted under said top surface of said pad and emitted at said second ends of said optical fibers as points of light in said predetermined pattern.
